(19) United States
(12) Patent Application Publication
(10) Pub. No.: US 2024/0420144 A1
(43) Pub. Date: Dec. 19, 2024

(54) FRAUD IDENTIFICATION AND PREVENTION IN PAY GROUPS

(71) Applicant: Wells Fargo Bank, N.A., San Francisco, CA (US)

(72) Inventors: Peter Rozovski, Concord, CA (US); Tina D. McCoy, Charlotte, NC (US); Rhya Volkwein, Stamford, CT (US); Shrisha R. Yelluru, San Francisco, CA (US); Ravi K. Thota, San Francisco, CA (US)

(21) Appl. No.: 18/333,805

(22) Filed: Jun. 13, 2023

(51) Int. Cl. G06Q 20/40

(52) U.S. Cl. CPC G06Q 20/4016

(57) ABSTRACT

Various examples are directed to systems, methods, and computer programs for detecting fraudulent activity and/or fraudulent actors in transaction requests associated with pay groups in a financial institution. For example, a financial server receives a transaction authorization request related to a pay group on an account of a user. The financial server monitors events associated with at least one payee of the pay group and identifies a fraud indication among a first event of the events associated with the at least one payee of the pay group. The financial server blocks the transaction authorization request related to the pay group, including triggering, by the fraud indication, stopping multiple payments to multiple payees of the pay group.

### TECHNICAL FIELD

Embodiments described herein generally relate to systems, methods, and computer programs in the field of online banking and/or financial services, and more specifically, to methods for fraud detection in digital banking channels working with pay groups. For example, embodiments described herein generally relate to systems and methods for fraud detection in pay groups using financial services systems.

### BACKGROUND

Customers of financial institutions are sometimes victims of fraud where a third-party takes advantage of weaknesses or flaws to gain unauthorized access to a customer's account. Such malicious activities are aimed at compromising the integrity, confidentiality, and availability of the customers and financial institutions.

In online banking, fraud detection is the process of identifying and preventing fraudulent transactions in digital banking channels (e.g., electronic payments, mobile banking, online banking, etc.). As the use of online banking and financial institutions increases, fraudsters have become more sophisticated in their methods, making fraud detection and prevention increasingly important. Currently, banks use a variety of methods of fraud detection such as fraud scoring, machine learning, multi-factor authentication, geolocation, behavioral analysis, and the like. For example, banks can use fraud scoring systems to assign a risk score to each individual transaction based on factors such as customer transaction history, transaction amount, location, etc., where high risk scores can be flagged for further review. Using machine learning algorithms, banks can identify patterns in data that can indicate fraudulent activity based on learned historical data. Financial institutions can use geolocation data to determine the physical location of a user when the user is conducting a transaction, if a transaction is initiated from a location that is unusual for that customer, the bank can flag the transaction as potentially fraudulent. In addition, banks can employ behavioral analytics systems to monitor a customer's typical online banking behavior (e.g., login times, transactions, locations, history, etc.). If there is an unusual deviation from this user's behavior, the bank can flag the transaction as a possible fraud scenario.

Detecting and properly responding to fraudulent usage of an account may present a difficult challenge for service providers. On the one hand, if proper detection and safeguards are not in place, great harm may come to an institution and its members, customers, and users when fraud occurs. On the other hand, if overly aggressive policies are implemented, there is a risk that valid users may become upset. Attaining a proper balance poses a difficult technical challenge in determining when fraudulent account usage is occurring, avoiding false positives/negatives, and determining appropriate levels of response to detected fraud.

### BRIEF DESCRIPTION OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. The drawings illustrate generally, by way of example, but not by way of limitation, various embodiments discussed in the present document. Various embodiments in accordance with the present disclosure will be described with reference to the drawings, in which:

FIG. 1 is an illustration of components of a financial institution server and a client device, in accordance with some embodiments.

FIG. 2 is a diagram showing one example of an environment for interfacing between a computing device and a fraud detector of a financial services system, in accordance with some embodiments.

FIG. 3 is a diagram showing an example of fraud detection and prevention in banking enrollment, in accordance with some embodiments.

FIG. 4 is a diagram showing examples of fraud detection responses in response to fraudster activities, in accordance with some embodiments.

FIG. 5 is a flowchart showing one example of a process flow for detecting and blocking fraudulent activity, in accordance with some embodiments.

FIG. 6 is a flowchart showing one example of a process flow for analyzing and processing fraudulent actions in a digital pay system, in accordance with some embodiments.

FIG. 7 is a block diagram showing an example architecture of a user computing device, in accordance with some embodiments.

FIG. 8 is a block diagram showing one example of a software architecture for a computing device, in accordance with some embodiments.

FIG. 9 is a block diagram illustrating a computing device hardware architecture, within which a set or sequence of instructions can be executed to cause a machine to perform examples of any one of the methodologies discussed herein, in accordance with some embodiments.

### DETAILED DESCRIPTION

Example methods, systems, and computer programs are directed to detecting and preventing fraud to customers of a financial institution. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

### Overview

Example embodiments of the present disclosure are directed to systems, methods, computer programs, and machine-readable mediums that include a financial system, such as a financial institution, an online banking system, or financial service, configured to detect, identify, and prevent fraudulent activities attempted by fraudsters interfering with pay groups via the financial system. For example, the present disclosure facilitates recognizing and blocking fraud in online money transfers between a payor (e.g., an employer) and a group of payees (e.g., two or more employees) via a group payment (e.g., single transaction involving group pay). With the increasing use of online banking channels, the risk of fraudulent activities by bad actors has also increased. By implementing the systems, methods, and programs presented herein, banks and financial institutions can enhance their fraud detection capabilities and provide customers with a secure and reliable online banking experience by stopping all payments in a pay group if even a single payment is identified as fraudulent or flagged for possible fraud. In additional examples, the fraud indication triggers the stopping of multiple payments to multiple payees of the pay group. Which could include stopping one or more payments to one or more payees of the pay group, stopping a grouping or set of payments to a grouping or setoff payees of the pay group, or stopping all payments to all payees of the pay group. Customers of a financial institution can employ services (e.g., direct deposit, Automated Clearing House (ACH) payments, prepaid debit cards, bill pay, etc.) that combine payments and/or payees into groups referred to as “pay groups” in order to make bulk payments to two or more payees.

As used throughout example embodiments of the present disclosure and for the purposes of this description, the phrase “pay groups” may be referred to as and used interchangeably throughout with the term “batch.” For purposes of this description, the term “pay group” generally refers to a financial institution feature or service that allows users to make multiple payments at once. For example, a pay group or batch can be a collection of related transactions that are created and processed together in a single set or file in order to streamline processing, improve efficiency, and reduce costs. With regard to pay groups, a technical challenge arises as a financial institution system may need to access and process information associated with multiple payees, multiple payments, multiple activities, and/or the complex inter-relationships between each element of a pay group in order to properly monitor and prevent fraudulent activities. Pay groups or batches can further be used by the financial institution system to help identify and prevent fraudulent actors and/or fraudulent actions using fraud detection processes on the pay group or batch.

Pay groups are useful for situations where a user wants or needs to make payments to multiple recipients (e.g., payees), such as paying bills to multiple service providers or making payments to multiple employees in one group. Pay groups enabled by a banking system can save users time and effort by eliminating the need to create and submit multiple individual payments to each payee. Pay groups or groups of transactions can further simplify the banking process by creating and performing a set of related transactions that are processed together in a single batch. For example, instead of processing each transaction individually, the user (e.g., customer, payor) can generate, and the bank can process the pay group all at once, which can save time and reduce processing costs. In addition, grouping transactions together into pay groups can further help the payor with tracking and reconciling payments by organizing related transactions into groups. The payor can easily review and verify the accuracy of the transactions to ensure all payments, transfers, and/or deposits are accounted for. While such grouping of transactions may be convenient for customers and financial institutions alike, the use of pay groups also allow fraudulent actors (e.g., fraudsters) to attack one or more payees in a pay group at the same time.

In order to combat the rapid rise in digital payments fraud, financial institutions must ensure that each and every online or electronic payment from each payor to each payee is a valid transaction. However, traditional approaches for detecting or preventing online or electronic fraud attacks use automated systems to review and clear each individual payment and/or each individual payee in a pay group, and block payees on an individual basis. For example, commonplace systems use automated logic to identify fraudsters one transaction at a time (e.g., one payee/one payment). However, such systems fail to identify and prevent fraud in pay groups because they only review singular transactions and fail to identify fraudster attacks on groups of transactions (e.g., pay groups). Such conventional systems are insensitive to the correlation of payees and/or payments in a pay group as a whole. Existing financial institutions using fraud detection mechanisms fail to consider the difference between viewing each payment as fraudulent and blocking individual fraudulent payments and viewing each pay group as fraudulent and blocking all payments in the pay group.

In addition to standard fraud activity in post-pandemic situations, there are additional fraud activities related to online, real-time or near real-time operations of pay groups, which in pre-pandemic times were only available in a person-to-person regime. Conventional systems attempt to solve this problem using standard approaches to incorporate fraud score estimation, fraud identification, and fraud prevention systems and subsystems into payment systems without changing or updating the design of the payment systems. For example, currently, most conventional payment systems include fraud score estimation, fraud identification, and/or fraud prevention subsystems. However, without fraud-aware limits in pay group systems, existing fraud detection subsystem approaches cannot prevent fraud in many pay group scenarios.

Example embodiments of the present disclosure improve upon existing fraud detection models and overcome current technical challenges by providing a multi-step group process for identifying fraudulent activity for single payments in a pay group, then deciding a group-level decision for all payments in the pay group. For example, if there are fifty payments in a pay group, the system will perform fraud detection on a first single payment, if the first single payment is identified as fraudulent or possibly fraudulent, then the system will label the entire pay group as fraudulent without having to check each individual payment. If the system identifies the first single payment as allowable (e.g., non-fraudulent), the system will continue to perform fraud detection on individual payments of the pay group until any one payment is identified as fraudulent or possibly fraudulent. At the identification of any single payment in the pay group being labeled as fraud, the entire pay group will be labeled as possibly fraudulent and require additional fraud prevention as described herein. The group-level decision for a pay group can include one or more flexible set(s) of fraud prevention and/or identification rules in a rule's engine on a per-group or per-customer basis. This technical solution advantageously enables financial institutions to impose flexible limits to restrict enrollments and/or payments that are most at risk for fraudulent activity related to pay groups.

The group-level decision making can also include the usage of banking actions related to a pay group system design to detect, prevent, and/or minimize possible fraudulent actions on the pay group as a whole. For example, banking actions related to a pay group can include, but are not limited to, methods of account opening (e.g., in-person or online activation), limits on enrollment, limits on login, payment limitations, create payee functions, customer tenure with the financial institution, history of known fraudulent actor, history of identified fraudulent accounts, fraud blocklists, and the like. Example embodiments include flexible decision logic to introduce limits on customer actions in pay group services to minimize the negative impact from fraud. Where the flexible decision logic can be related to login attempts, successful logins, enrollment, adding and/or editing payee(s), adding and/or editing payment(s), and other payment applications. Where the limits on customer action in pay group services can be related to binary limits (e.g., yes/no), delay limits, range limits, tenure limits, authentication limits, and the like.

Pay groups can be implemented in payroll and employee management systems within companies in order to group employees of the company together for the purposes of administering payroll, benefits, and the like. In some example embodiments, a pay group may can be implemented by a payor (e.g., a company, an employer, etc.) in order to pay a group of payees (e.g., employees, vendors, etc.) during a specific time period or over a specified frequency such as a pay period (e.g., every two weeks). In the pay group, the group of payees may be part of a pay group, to which the payor pays salaries every two weeks. The payor can make certain changes to the pay group before or after each pay period, such as temporarily excluding employees on unpaid leave, permanently removing employees who left the company, changing payment amounts for one or more payees (e.g., hourly-based payments), and the like. In some examples, the payor (e.g., a company) may have other periodic or aperiodic payments cycles that include payments for rent, utilities, suppliers, etc. that can be clustered into a pay group of company expenses.

In additional examples, a bill pay service of a financial institution enables the financial institution customer (e.g., a company) to make multiple payments at once for users (e.g., payees) who receive their payments in periodic cycles (e.g., every two weeks, monthly, etc.). Certain online financial institution systems can include bill payment systems that provide for transactional exchange of funds (e.g., money) between accounts inside or outside the same financial institution. For example, an account owner (e.g., customer of the financial institution) initiates a pay group transaction via a bill payment system that is configured to transfer funds from a bill payment account into multiple (e.g., two or more) third-party accounts, such as employee accounts, vendor accounts, and so on.

When a financial institution enables customers to use pay groups, the banking system must determine if the actions, requests, and activities associated with the pay group are legitimate or fraudulent before processing the payment order (e.g., transferring funds from the payor account to all of the payee accounts) For example, the financial institution must identify if the action related to the pay group was initiated by a valid user (e.g., correct customer or actor) or if the request for an action related to the pay group was performed by a fraudster (e.g., a person or group that accessed the system by fraudulent attack, by illegal purchase of correct credentials, etc.). Example embodiments further overcome existing failures in technology by improving the functioning in computer systems by improving concurrency (e.g., in identifying fraud across multiple payees of a pay group at the same time), scalability (e.g., in determining fraud for an entire pay group), and resource consumption (e.g., in preventing fraud for all payees of a pay group) when determining fraudulent activity in pay groups.

Example embodiments include applying fraud detection and prevention analysis to logical groupings of pay groups (e.g., paying group dividends or periodic payments to groups of people) and/or mechanical groupings of pay groups (e.g., payments occurring during a specific time period or processed by a particular system, where access may be more prone to fraudulent activity via vulnerabilities associated with the pay group (e.g., multiple payees in a single transaction, recurrent payments, automated transfers, etc.). The system can automatically generate a fraud detection response based on, for example, a likelihood of potential fraud, a type of potential fraud, prevented fraud attempts, unconfirmed fraud, designation of fraudulent characteristics, post-designated fraud, and other digital payment fraud activities. Where post-designated fraud can include, for example, fraud detected after a transaction related to a pay group has occurred and was later detected, this later detected fraud can be labeled in a log associated with the pay group, such as a historical database or fraud blocklist database. Where the automated fraud detection response can enable the system to block the attempted action when fraud is detected or allow the action when no fraud is detected. Thus, example embodiments of the present disclosure solve the technical problem of detecting and preventing fraudulent activity on groups of payments in a digital payment system, including fraud-aware monetary and non-monetary flexible limits in payment applications.

### Detailed Embodiments

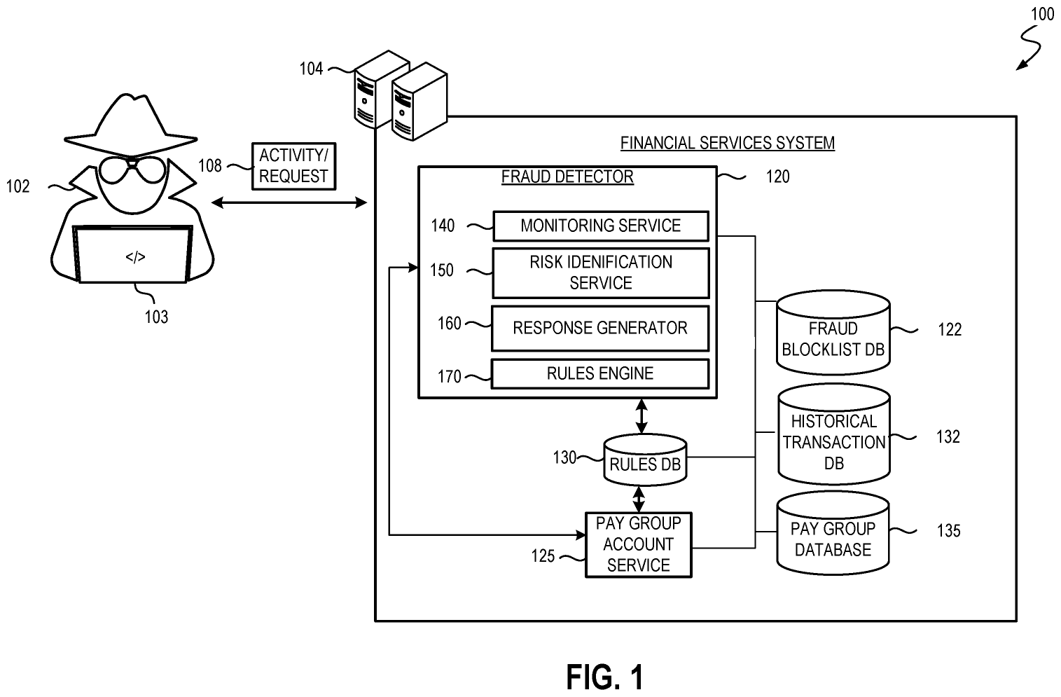

FIG. 1 is an illustration of a schematic diagram of an environment 100 including components interacting with a financial services system 104, according to various examples. In certain examples, the financial services system 104 can be part of a larger system such as, but not limited to, a bank computer system or an investment firm computer system.

The environment 100 includes the financial services system 104 being accessed by a fraudster 102 via a fraudster client device 103 to initiate fraudulent activities or requests 108. The fraudster client device 103 can be a computing device which may be, but is not limited to, a smartphone, tablet, laptop, multi-processor system, microprocessor-based or programmable consumer electronics, game console, set-top box, or other devices that a user utilizes to communicate over a network. In various examples, a computing device includes a display module (not shown) to display information (e.g., in the form of specially configured user interfaces). In some embodiments, computing devices may comprise one or more of a touch screen, camera, keyboard, microphone, Global Positioning System (GPS) device, and the like.

The fraudster client device 103 and the financial services system 104 can communicate the request 108 (e.g., transaction data) via a network (not shown). The request 108 can include, in various examples, user financial data, user selection data, graphics for display on client device 103, and/or other data used according to example embodiments. In some examples, the communication may occur using an Application Programming Interface (API), which provides a method for computing processes to exchange data. A web-based API can permit communications between two or more computing devices such as a client and a server. The API can define a set of HTTP calls according to Representational State Transfer (RESTful) practices. For example, A RESTful API can define various GET, PUT, POST, DELETE methods to create, replace, update, and delete data stored in a database.

The financial services system 104 includes a fraud detector 120 operatively connected with one or more pay group account services 125, both of which can access different databases including a fraud blocklist database 122, a historical transaction database 132, a pay group database 135, and/or a rules database 130. Financial services system 104 is illustrated as a set of separate elements (e.g., components, circuits, logic, etc.); however, the functionality of multiple, individual elements can be performed by a single element or multiple distinct application servers for the financial institution. An element can represent computer program code that is executable by a processing system. The program code can be stored on a storage device (e.g., data store) and loaded into a memory of the processing system for execution. Portions of the program code can be executed in parallel across multiple processing units (e.g., a core of a general-purpose computer processor, a graphical processing unit, an application specific integrated circuit, etc.) of the processing system. Execution of the code can be performed on a single device or distributed across multiple devices. In some example embodiments, the program code can be executed on a cloud platform (e.g., MICROSOFT AZURE®, AMAZON EC2®, etc.) using shared computing infrastructure.

Described below is a financial services system 104 that detects fraud in pay group systems utilizing advanced pattern recognition, blocklist databases including information on known or suspected fraudulent actors and/or known or suspected compromised accounts, and statistical historical transaction records as a basis for determining fraudulent activity and/or fraudulent actors. The ability to use past activity (e.g., historical transaction database 132) combined with patterns of others and analyze data relationships makes a technically more efficient and more accurate fraud processor in pay group scenarios that helps to reduce false positives and negatives and may be utilized in a number of technical applications.

The fraud detector 120 includes a monitoring service 140, a risk identification service 150, a response generator 160, and a rules engine 170, one or all of which are configured to be used according to a set of rules, stored in the rules database 130, in order to detect, monitor, and respond to fraudulent activities in or related to pay groups of an account of a financial institution. The monitoring service 140 and/or the risk identification service 150 can be used for identifying potentially fraudulent requests allowing the vast majority of requests, which are not fraudulent, to be handled quickly and efficiently. Without being able to identify potentially fraudulent requests, all requests may be subjected to additional screenings, which could increase processing time for all distribution requests.

Once the monitoring service 140 and/or the risk identification service 150 identify actual or potentially fraudulent activities or actors, the response generator 160 can be used for routing potentially fraudulent requests for additional screening and additional verification helps eliminate fraudulent requests. Using various described embodiments, the response generator 160 can determine automatic or manual responses to identified fraud. For example, processing time for valid requests may be reduced, while potentially fraudulent requests related to many payees in a pay group are identified and subjected to additional verification. Example embodiments of the response generator 160, alone or in combination with the rules database 130, can facilitate response(s) to known, suspected, potential, or otherwise identified fraudulent activity and/or fraudulent actors. In some example embodiments, the response generator 160 can perform one of three major actions. A first action is to do nothing, or allow the transaction, request, or action by approving the action. The second action is to block all actions based on a determination of clearly identified fraud. The third action is to block all actions and send the request to a secondary fraud detection analysis (e.g., fraud officer) when the action is identified as possible (e.g., unsure) fraud.

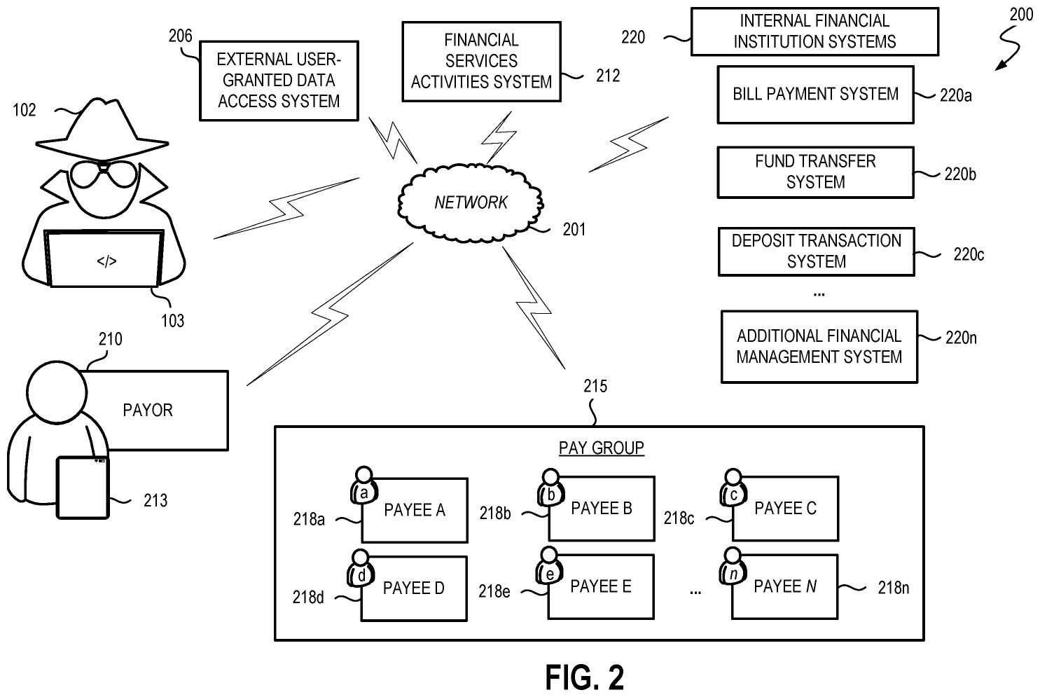

According to example embodiments, the fraud detector 120, the rules database 130, and/or the pay group account service 125 can be operatively connected with one or more databases such as, the fraud blocklist database 122, the historical transaction database 132, and pay group database 135. In certain examples, the historical transaction database 132 and/or the pay group database 135 can include account information about asset accounts held by the bank or the investment firm for various account owners. In some examples, the account information can include information such as address, date of birth, current monetary balances, etc. associated with the account or the account holder, and/or the payees associated with a pay group. In some examples, the account information can include historical transaction information including amounts and names associated with each deposit, withdrawal, or transfer of assets associated with the pay group. The pay group account service 125 includes information related to the pay group (e.g., pay group 215 described and depicted in detail in connection with FIG. 2). Once a pay group is selected, all of the included users in the pay group become payees for the transfer, where the money transfer is a single transaction that pays a group of payees all in one action.

The fraud blocklist database 122 can include one or more lists, generated from within the financial institution or received from external sources (e.g., Internet), that are blocklists. A blocklist can include a list of credentials, such as usernames and/or passwords, which have been identified by a source as being compromised or associated with fraudulent or suspicious activities. In some examples, the credentials stored in blocklists can vary; for example, blocklists can store credentials that have been flagged or labeled as suspicious by an automated fraud detection system, credentials associated with known malicious domains or IP addresses, credentials that have been identified as part of past brute-force attacks, and/or legitimate account identifiers that have been compromised in a security incident within the financial institution or from an external source (e.g., other Internet login security incident). For example, blocklists can include lists of known or suspected fraudsters, lists of known or suspected compromised accounts (e.g., known usernames/passwords associated with user accounts at the financial institution or of payees in the pay group), or In additional examples, other block lists can include events, metrics, or data related to known or suspected fraudulent activities or actors associated with or related to any of the users (e.g., payees or payors) of the financial institution.

Additional example embodiments of the fraud blocklist database 122 can include one or more databases for generating and maintaining lists or receiving lists from sources external to the financial services system 104 that include fraudulent activity that was detected after a pay group transaction had been completed. For example, such post-designated fraudulent activity can include lists of actions and identifiers (e.g., IP addresses, account names, etc.) that led to a fraudulent activity that could affect a legitimate customer of the financial institution. These post-designated fraudulent activities can be stored in the fraud blocklist database 122 for future use of the system.

The historical transaction database 132 can include historical transaction data related to all legitimate payees and/or payors of the financial institution. For example, the financial services system 104 can compare the transaction being attempted via request 108 to other transactions made by the actual payor associated with the pay group, other transactions made by customers similar to the actual payor, or other historical information related to one or more payees of the pay group. If the transaction deviates from transactions described by the historical transaction data in the historical transaction database 132, then the risk identification service 150, alone or in combination with one or more rules of the rules database 130, can determine that the request 108 is fraudulent or possibly fraudulent.

Example embodiments of financial services system 104 and components thereof, like the historical transaction database 132, in combination with the monitoring service 140 and risk identification service 150 can identify fraudulent activity and/or fraudulent actors (e.g., fraud) in order to analyze characteristics of events, actions, activities, and the like and identify fraud risks. For example, components of the financial services system can identify a transaction or a specific context of an activity and determine a probability or likelihood that the transaction or activity is fraudulent at some level (e.g., fraudulent actor, fraudulent activity, fraudulent combination, etc.).

The monitoring service 140 can monitor characteristics and events related to pay groups, such as monitoring an access point for activity related to a pay group, in order to monitor for fraud. Where an access point could be a Wi-Fi router, a Bluetooth® receiver, an automated teller machine (ATM), or other Internet access point for connecting to the financial services system 104 or other financial institution services. For example, the monitoring service can determine whether an access point or activity associated with a pay group access from that access point should be flagged as potential fraud. In another example, the monitoring service can correlate verified offline fraud events (e.g., fraud identified by a user) to potential online fraud activity, including, for example, detecting online and/or offline historical fraud events and comparing historical events to a risk threshold. In additional example embodiments of the monitoring service 140, the system can retroactively identify past fraudulent activity and correlate the activity with current users (e.g., payees, payors) of a pay group.

The risk identification service 150 can analyze characteristics of events in comparison to static or dynamic threshold values, alone or in combination with other factors, associated with a pay group in order to determine actual or potential fraud. For example, the risk identification service 150 can review a cluster of events, associated with a fraud event, a fraudulent action, a fraudulent activity, and/or a pattern of fraudulent activities associated with a pay group, such as related to time, place, access point, types of access point, etc., and determine if any characteristic or event related to the pay group signifies fraud. In additional example embodiments, the risk identification service 150, alone or in combination with the rules engine 170 (detailed below), can identify and implement pay group-level decision making to identify characteristics associated with a pay group. For examples, the usage of banking actions related to a pay group can include, but are not limited to, methods of account opening (e.g., in-person or online activation), limits on enrollment (e.g., time delays, monetary limits, etc.), limits on login, payment limitations, create payee functions, customer tenure with the financial institution, history of known fraudulent actor, history of identified fraudulent accounts, fraud blocklists, and the like. These characteristics can be used to analyze events associated with each payee of a pay group and designate any characteristics as possibly fraudulent. Where such a designation for a single payee of the pay group would cause the risk identification service 150 to designate the entire pay group (e.g., all transactions for all payees of the pay group) as possibly fraudulent and blocking the attempted transaction for the entire pay group.

The pay group database 135 can include any information or data related to pay groups associated with a customer's account. For example, an amount of money transferred to each payee in the last pay period, names of payees, number of payments made to payees of the pay group, and the like.

The rules database 130 can include entity grouping algorithms that utilize specified rulesets (e.g., if-then rules, etc.), machine learned models, or the like that use description data of users (e.g., payees) of the pay group as input to decide as to whether any possible, potential, likely, or actual fraudulent activity is associated with at least one user (e.g., payee) of the pay group. Example machine-learning algorithms include machine-learned clustering algorithms. In some examples, the clustering algorithms may be supervised in that each user (e.g., payee) may have a label of which group the user (e.g., payee) should be placed into. In some examples, a multi-level fraud identification algorithm includes: (1) existing old identification of payments and (2) new decision of pay group. In other examples, a multi-level fraud identification algorithm includes, for example: (1) Identifying known fraudsters and (2) identifying known vulnerable accounts. Identifying fraudulent interactions or actions in a pay group when fraudsters attempt to gain access or succeed in gaining access to pay groups (e.g., group of transactions, groups of payments, group bill pay, group payments, etc.).

An example embodiment of the rules database 130 can include or be operatively connected with a rules engine 170 that is configured to provide a multi-step group process for first identifying fraudulent activity for single payments in a pay group, then second deciding at a group-level (e.g., for all payees in the pay group, for all payments in the pay group, etc.) decision for the entire pay group with or without identifying fraud in other payments or payees of the pay group. For example, the first part of the multi-step group process includes using existing fraud prevention and detection algorithms, services, and/or systems to identify fraud on a single payment, payee, transaction, etc. level for each individual person in the pay group. Once fraud or suspected fraud is found for any singular individual person that is part of the pay group, the rules engine 170 initiates the second part of the multi-step process. For example, the second step of the multi-step process can include preventing all transactions or payments to all payees of the pay group based on the identification of one detection of possible fraudulent associated with one payee of the pay group. The second step is a group-level decision for the pay group (e.g., all payees in the pay group are treated the same) and can include one or more flexible sets of fraud prevention and/or identification rules in the rules engine 170 on a per-group or per-customer basis (e.g., per pay group, per payor, etc.). For example, the rules engine 170 can implement group-level decision making for a pay group based on logical groupings or mechanical groupings associated with the pay group. Where a logical grouping can include groups of transaction or activities that are organized based on the purpose or meaning of the pay group (e.g., grouped together based on payments to employees, grouped together based on expenses to vendors, or other logical relationships associated with the pay group). Mechanical groupings can include groups of transactions that are organized based on technical or procedural criteria related to the pay group (e.g., time of processing, server used to process transactions associated with the pay group, geographical groupings, or other groupings based on objective criteria). The group-level decision enables the financial services system 104 to impose flexible limits to restrict enrollments and/or payments that are most at risk for fraudulent activity related to pay groups.

In the example embodiment of FIG. 1, when creating a pay group, an actor typically needs to provide certain information, such as the recipients' names, account numbers, payment amounts for each payment, and the like. Once the pay group is created, the actor can submit payments to the bank for processing to every member of the pay group with a single (or few) selection. Pay group can save users time and effort by eliminating the need to create and submit multiple individual payments to each member individually. Pay groups further help to reduce the risk of omissions or errors in payment information as all payment details can be verified and reviewed before submitting the payments.

In addition to groups of people, pay groups can also be used for groups of transactions. For example, a pay groups typically refers to a set of related transactions that are processed together in a single batch. These transactions can be of various types, such as payments, deposits, transfers, and the like. In business banking, groups of transactions are commonly used to manage payroll and accounts payable transactions. For example, a company can submit a group of transactions that includes all of the payments for employee salaries and vendor invoices for a period of time (e.g., pay period) in a pay group. The benefit of grouping transactions together can help the user with tracking of payments or transactions as well as reconciliation. By organizing related transactions into groups, the user can more easily review and verify the accuracy of the transactions and ensure that all necessary payments, deposits, or other transactions are accounted for. Groups of transactions can help streamline payment and accounting processes for businesses and individuals.

Batching transactions together helps to streamline processing, reduce costs, and improve efficiency for banks and other financial institutions. A batch typically refers to a collection of related transactions that are processed together in a single file or set, typically in a specific order. For example, payroll batches can include a batch of employee payroll transactions, such as salaries, taxes, wages, etc. that are processed together by an employer. Another example is billing batches, where a batch of invoices is generated by a company or service provider and they are processed together, typically for billing clients and customers. Batches can refer to other groupings, such as deposit batching, credit card batching, wire transfer batching, and other such groups of related transactions, persons, or actions that are processed together.

FIG. 2 is a diagram showing an environment 200 for interfacing between a computing device including additional details, according to example embodiments. In some examples, the environment 200 can include the same computing environment as the environment 100 depicted and described in connection with FIG. 1. FIG. 2 is similar in many respects to FIG. 1, sharing certain similar features and components; for brevity, only specific elements are detailed and described with reference to FIG. 1. To avoid obscuring the inventive subject matter with unnecessary detail, various functional components that are not germane to conveying an understanding of the inventive subject matter have been omitted from FIG. 2. However, a skilled artisan will readily recognize that various additional functional components may be included as part of the environment 300 to facilitate additional functionality that is not specifically described herein. In other embodiments, the environment can comprise another type of network-based database system or a financial platform.

In the example of FIG. 2, user computing devices 103, 213, an external user-granted data access system 206, a financial services activities system 212, internal income system 220, and a pay group 215 are in communication with one another via a network 201. The network 201 can be or comprise any suitable network element operated according to any suitable network protocol. The network may include local-area networks (LAN), wide-area networks (WAN), wireless networks (e.g., 802.11 or cellular network), the Public Switched Telephone Network (PSTN) Network, ad hoc networks, cellular, personal area networks, or peer-to-peer (e.g., Bluetooth®, Wi-Fi Direct), or other combinations or permutations of network protocols and network types. The network may include a single Local Area Network (LAN) or Wide-Area Network (WAN), or combinations of LAN's or WAN's, such as the Internet. For example, one or more portions of the network 201 can be an ad hoc network, an intranet, an extranet, a virtual private network (VPN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, another type of network, or a combination of two or more such networks, etc.

The financial services system 104 can further be connected with a legitimate account owner or customer (e.g., payor 210) via the computing device 213 and/or the fraudster 102 using the fraudster client device 103 via the network 201. The internal financial institution systems 220 can include a bill payment system 220a, fund transfer system 220b, deposit transaction system 220c, and additional financial management systems 220n, such as withdrawal transaction systems, investment management systems, loan management systems, and the like. The internal financial institution systems 220 can include all or a select group of systems directly associated with the financial services system 104 through which the payor 210 maintains financial accounts and provides payments to the pay group 215.

In some examples, the pay group account service 125 can include account information related to each member of a pay group 215, such as historical transaction information including amounts and names associated with payments. For example, each pay group 215 can include any number of payees (e.g., 10 payees or 2000 payees) depending on the pay group needs. In the example of pay group 215, there are six payees, including payee A 218a, payee B 218b, payee C 218c, payee D 218d, payee E 218e, and payee N 218n. The payees 218a-n in pay group 215 can include any number of payees, such as all employees of an employer.

The bill payment system 220a can include an online banking system, such as the financial services system 204, that enables the user to make bill payments to merchants, service providers, payees, and the like. The fund transfer system 220b can use the online banking system to transfer funds between the user's own accounts or to send money to external businesses or individuals. The deposit transaction system 220c can allow the user to deposit funds from their accounts.

The example embodiment of FIG. 2 further depicts a financial services activities system 212 that is operably connected to the payor 210 via the network 201. The financial services activities system 212 can be a component of the financial services system 104 or operably interconnected therewith. The financial services activities system 212 can include data derived or generated by the financial services system 104 or macro-economic activities related to research, guidance, blocklists, and the like associated with fraudulent activities, fraudulent actors, payors, and/or payees. The financial services activities system 212 enables additional information to be generated by external sources and provided to or imported by the financial services system.

The external user-granted data access system 206 enables the payor 210 (e.g., legitimate customer) to provide or permit access to one or more external sources of financial or other personal information relating to the payor 210. Additionally, external user-granted data access system 206 can get the payor 210 and/or one or more of the payees 218a-218n to tie in external accounts that are not specific to the financial services system (e.g., external banks, external credit card companies, etc.).

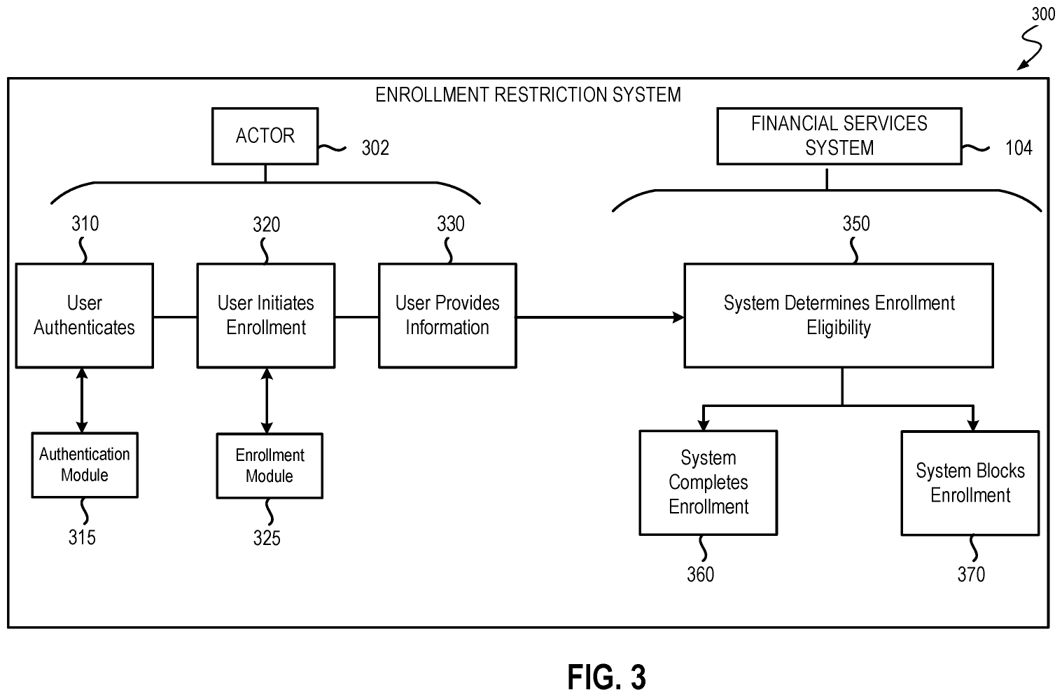

FIG. 3 is a block diagram showing an example enrollment restriction system 300 between an actor 302 and a financial services system 104, according to example embodiments. In most circumstances, an actor using an enrollment system as described in FIG. 3 would be a legitimate customer of the financial institution performing legal actions. However, the financial services system 104 according to example embodiments of the present disclosure must be capable of identifying when an actor is a fraudulent actor (e.g., fraudster 102) and not a legitimate customer (e.g., payor 210). Accordingly, the example embodiment of FIG. 3 depicts the enrollment restriction system 300 implementing a fraud-aware enrollment application to combat the rapid rise in digital enrollment fraud by restricting enrollment activities related to pay groups that are most at risk for fraudulent activity.

In the example of FIG. 3, the actor 302 can attempt an enrollment via the financial services system 104. At step 310, the actor 302 authenticates 310 accesses an enrollment interface by communication with an authentication module 315 of the financial services system 104. For example, the actor 302 connects either directly to a computer performing the function of authentication or connects over a network, such as the Internet, to enter the actor's authentication information (e.g., login credentials). The identity and authority of the actor to communicate with the financial services system are verified, for example, by verifying the actor's username and password associated with the financial institution. While this information may be accurate and verifiable by the financial institution, it does not mean that the actor 302 entering the login information is actually a customer (e.g., payor 210), and the actor 302 may actually be the fraudster 102 with stolen or illegally accessed login credentials. As such, further fraud detection methods are employed.

Once the user authentication 310 is accepted, the actor 302 initiates enrollment 320 via an enrollment module 325 associated with a pay group of the financial services system 104. The enrollment module 325 can prompt the actor 302 for customer information that is used to create, generate, update, schedule, and other actions related to pay groups. The actor 302 provides information 330 in response to relevant enrollment module 325 actions. For example, the enrollment module 325 can prompt the actor 302 to provide information related to, but not limited to, pay group payees, selection of an account for funding the pay group, selection of an account for receiving funds, a selection of a billing account for payment of fees, email addresses or contact information associated with the payor and/or payees of the pay group, and the like.

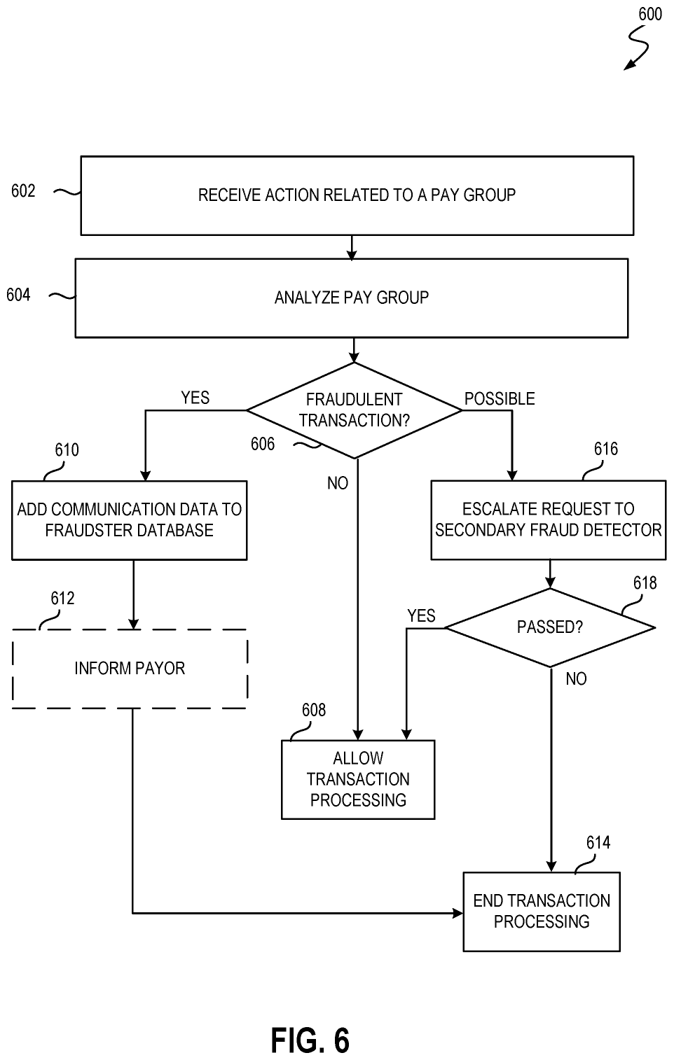

The financial services system 104, upon receiving the actor's request from enrollment, determines enrollment eligibility 350 based on the fraud detector 120 (described in more detail in connection with FIG. 6). The financial services system 104, based on the outcome of step 350, either completes enrollment 360 if the system determines there is no fraud or possible fraud, or blocks enrollment 370 if the system determines there is actual fraud or a possibility of fraud.

According to some example embodiments, if actual fraud or possible fraud is determined, the financial services system 104 can perform one or more operations to respond to the fraudulent activity. Enrollment restrictions can be implemented to protect the legitimate customer and pay group associated with the customer by implementing one or more flexible delay responses based on characteristics of the actor 302. For example, a flexible delay response can be implemented as a time-based delay (e.g., waiting x hours or days before allowing transactions) based on a minimum tenure after a customer opens an account in the financial institution can be implemented, where the delay value can depend upon varying methods of enrollment (e.g., in-person enrollment, online enrollment). For example, when a flexible delay response is desired, a delay value can be automatically or manually modified depending on if the enrollment (e.g., account opening) was attempted in-person at a financial institution branch versus an online enrollment attempt. In another example, a delay value can depend on whether the actor 302 uses different types of authentications (e.g., One-Time Password (OTP) vs. RSA SecureID). For example, high-limit payments can require a customer to use a two-factor authentication (e.g., RSA SecureID), which will make it more difficult for unauthorized users (e.g., fraudsters) to gain access to pay groups with high-limit payments. Further examples include the system enabling additional high-limit eligibility security measures; for example, high-limit eligibility requires customer to have specific attributes (e.g., require a minimum tenure with the financial institution).

According to some example embodiments, if a new user (e.g., actor, customer) of the financial institution (e.g., bank) attempted a first time or new account enrollment, the banking system can employ a flexible delay based on a minimum tenure after the customer opens an account with the financial institution. The flexible delay value can depend upon the user's method of action. For example, if a new user attempts to open a new account via the online system versus in-person at a branch of the bank, the delay may be adjusted for online attempts. In another example embodiment, if a user is attempting authentication, the delay value can be modified depending upon the type of authentication used.

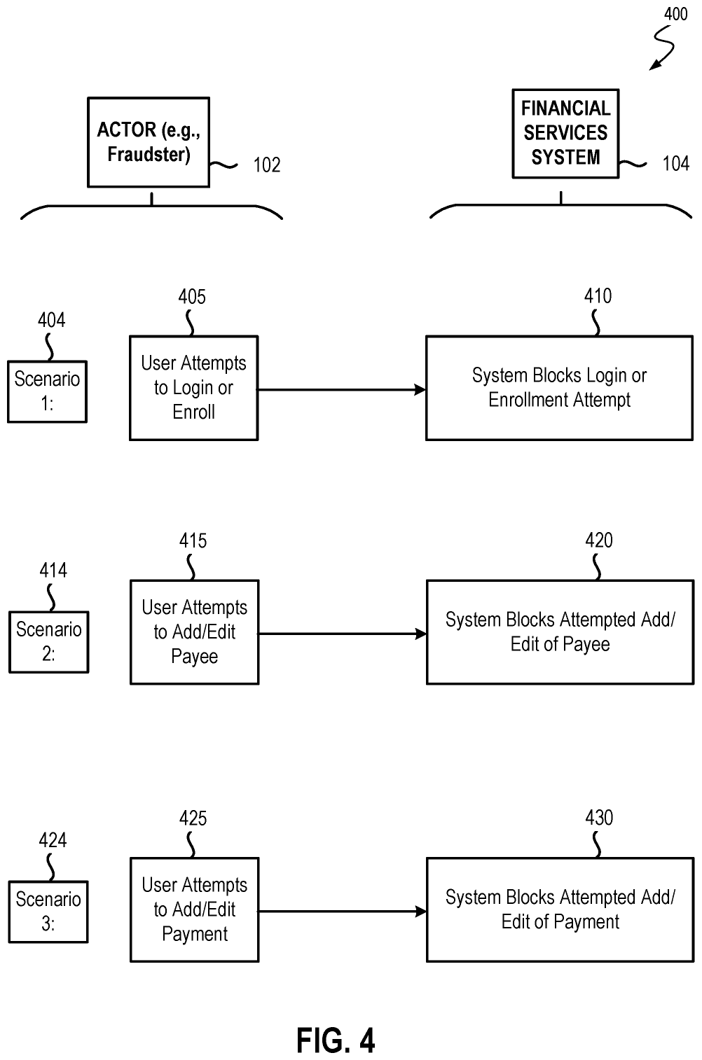

FIG. 4 is a diagram 400 showing three example scenarios between an actor 102 and the financial services system 104, according to some example embodiments.

In the example of FIG. 4, the actor 102, who is a fraudster, can attempt a variety of actions related to pay groups via requests to the financial services system 104. For example, the fraudster 102 can attempt to login to the financial institution, attempt to add or edit payees of the pay group, attempt to add or edit payments in the pay group, or attempt additional pay group related activities. In response to the example requests, or other requests applicable to pay groups, the financial services system can automatically perform one or more responses based on known or probable fraud detected.

For example, in a first scenario, scenario 1 404, the actor 102 attempts to login 405 to the financial institution or enroll into application using stolen or fraudulent credentials. If the financial services system 104 determines that the actor 102 is a fraudster, the system blocks the login attempt or the enrollment attempt 410. In scenario 1, the financial services system can determine that the actor 102 is a known or suspected fraudster by reviewing and comparing the fraudster's information to a fraudster blocklist generated by or accessed by the financial institution. The fraudster blocklist can contain relevant information about known or suspected fraudsters from Internet sources outside of the financial institution. For example, the fraudster blocklist can include names, screen names, aliases, characteristics, and the like related to known or suspected fraudsters that are gathered from actions or activities performed outside of the financial institution.

In a second scenario, scenario 2 414, the actor 102 attempts to add a new payee or to edit an existing payee 415 of one or more pay groups. If the financial services system 104 determines that the actor 102 is a fraudster, the system blocks the attempted addition or edit of the payee 420 of the pay group. In addition to blocking the addition or edit of the payee, the financial services system can decline all actions (e.g., payments, notifications, deposits, etc.) related to the pay group (e.g., all payees in the pay group).

In additional examples of scenario 2 414, the financial services system can compare each payee of the pay group to one or more compromised account blocklists used or maintained by the financial institution. For example, the financial services system can compare information about a first payee of the pay group to a compromised account blocklist that includes information related to people, events, accounts, etc. outside of the financial institution (e.g., from elsewhere on the Internet or associated databases or networks) with the financial institution's known data on the payee. This can be performed for every payee in a pay group. When the financial services system identifies any single one of the payees in the pay group as having possible or identified account information on a compromised account blocklist, the financial services system will block all actions (e.g., adding or editing of payees) associated with all payees in a pay group. In additional examples of scenario 2 414, the financial services system can use payees of the pay group to identify fraudulent accounts and/or fraudulent actors based on known legitimate users (e.g., payees).

In a third scenario, scenario 3 424, the actor 102 attempts to add or edit a payment 425 of the pay group. If the financial services system 104 determines that the actor 102 is a fraudster, the system blocks the attempted addition or edit of the payment 430 of the pay group.

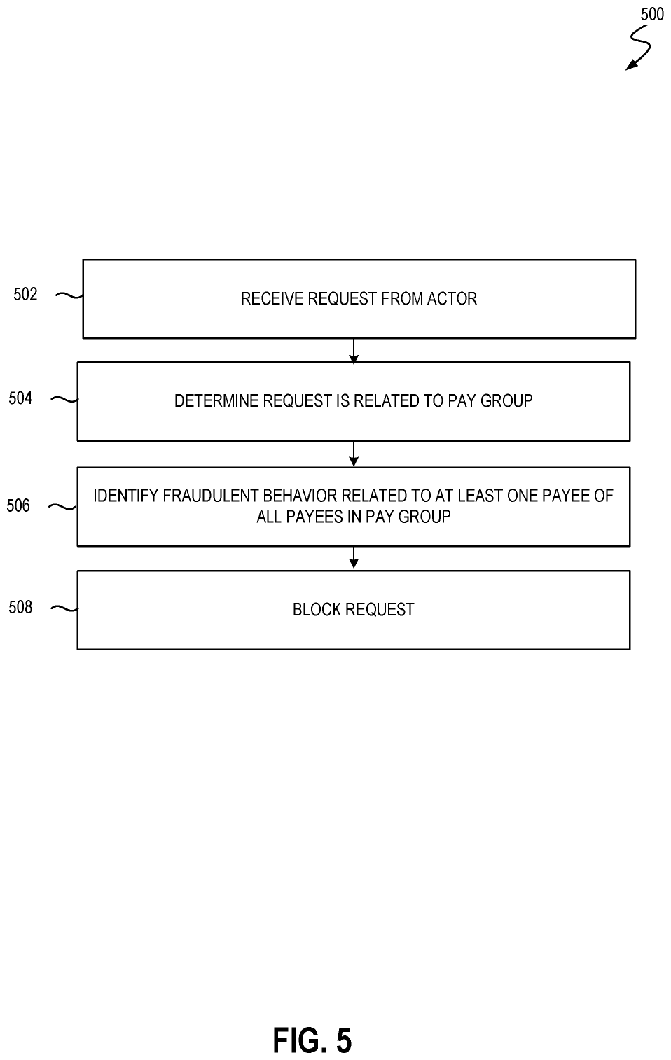

FIG. 5 is a flowchart showing one example of a process flow method 500 for identifying and preventing fraudulent actions related to a pay group, according to one example embodiment. The method 500 can be embodied in machine-readable instructions for execution by one or more hardware components (e.g., one or more processors) such that the operations of the method 500 can be performed by components of the fraud detector 120. Accordingly, the method 500 is described below, by way of example with reference to components of fraud detector 120. However, it shall be appreciated that method 500 can be deployed on various other hardware configurations and is not intended to be limited to deployment within the fraud detector 120.

Depending on the embodiment, an operation of the method 500 can be repeated in different ways or involve intervening operations not shown. Though the operations of the method 500 can be depicted and described in a certain order, the order in which the operations are performed may vary among embodiments, including performing certain operations in parallel or performing sets of operations in separate processes. While the various operations in this flowchart are presented and described sequentially, one of ordinary skill will appreciate that some or all of the operations may be executed in a different order, be combined or omitted, or be executed in parallel.

At operation 502, the fraud detector 120 receives a request from an actor. At operation 504, the fraud detector 120 determines the request is related to a pay group. At operation 506, the fraud detector 120 identifies fraudulent behavior related to at least one payee from out of all of the payees in the pay group. At operation 508, the fraud detector 120 blocks the received request.

FIG. 6 is a flowchart showing one example of a process flow for identifying and preventing fraudulent actions related to a pay group, according to one example embodiment. The method 600 can be embodied in machine-readable instructions for execution by one or more hardware components (e.g., one or more processors) such that the operations of the method 600 can be performed by components of the financial services system 104. Accordingly, the method 600 is described below, by way of example with reference to components of the financial services system 104. However, it shall be appreciated that method 600 can be deployed on various other hardware configurations and is not intended to be limited to deployment within the financial services system 104.

Depending on the embodiment, an operation of the method 600 can be repeated in different ways or involve intervening operations not shown. Though the operations of the method 600 can be depicted and described in a certain order, the order in which the operations are performed may vary among embodiments, including performing certain operations in parallel or performing sets of operations in separate processes. While the various operations in this flowchart are presented and described sequentially, one of ordinary skill will appreciate that some or all of the operations may be executed in a different order, be combined or omitted, or be executed in parallel.

The process flow 600 is described as being performed by the financial services system 104, although in some examples some or all of the process flow 600 is executed by a web server and/or the user computing devices 103, 213.

At operation 602, the financial services system 104 receives an action related to a pay group. For example, the financial institution receives a request, such as an action from an actor, to add or edit a payee, or to add or edit a payment related to a pay group. At operation 604, the financial services system 104 analyzes the pay group. For example, a fraud detector of the financial services system can analyze one or more behaviors, metrics, characteristics, or the like associated with each payee of all of the payees in a pay group.

At operation 606, the financial services system 104 determines if the transaction request is fraudulent. If the operation 606 determines that no, the transaction is not fraudulent, the process flow 600 continues to operation 608. At operation 608, the financial services system 104 allows the transaction related to the pay group to proceed.

If the operation 606 determines that yes, the transaction is fraudulent, the process flow 600 continues to operation 610. At operation 610, the financial services system 104 adds communication data to a fraudster database. The process flow continues to optional operation 612, where the financial services system 104 can inform the legitimate payor of fraudulent activity. For example, if a fraudulent actor (e.g., a fraudster) is detected as acting on a legitimate customer's account, the financial services system can inform the customer (e.g., send an email, initiate a phone call, transmit an SMS, etc.) of fraudulent or possibly fraudulent activity using the known customer's legitimate contact information (e.g., not communicating via the compromised account). After operation 610 or optional operation 612, the process flow 600 continues to operation 614, where the financial services system 104 ends the transaction processing.

If the operation 606 determines that the transaction is possibly fraudulent, the process flow 600 continues to operation 616. At operation 616, the financial services system 104 escalates the request to a secondary fraud detector. If the operation 618 passes the secondary fraud detector, the process flow 600 continues to operation 608. At operation 608, the financial services system 104 allows the transaction related to the pay group to proceed. However, if the operation 618 fails the secondary fraud detector, the process flow 600 continues to operation 614, where the financial services system 104 ends the transaction processing.

Another general aspect is for a system that includes a memory comprising instructions and one or more computer processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

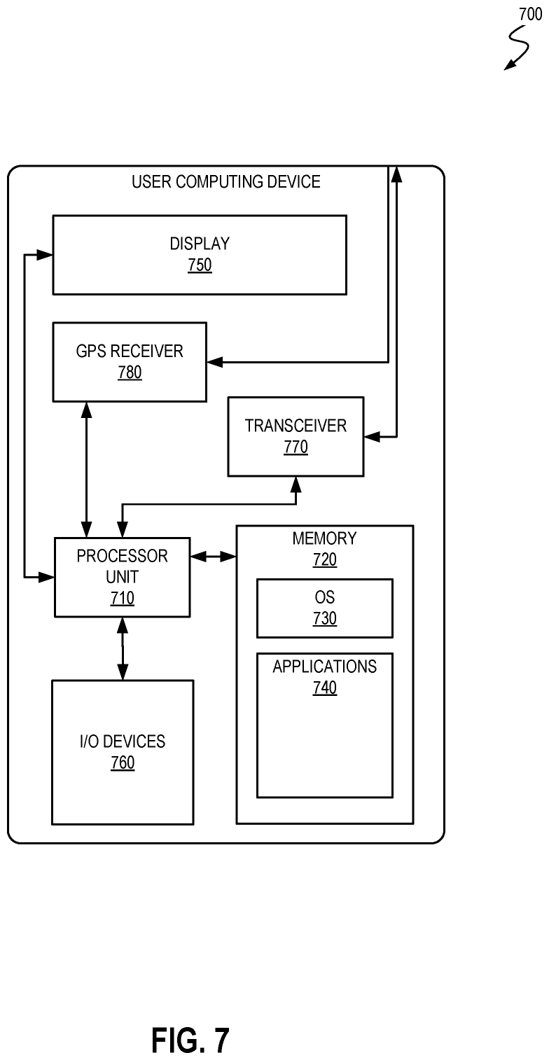

FIG. 7 is a block diagram showing an example architecture 700 of a user computing device. The architecture 700 may, for example, describe any of the computing devices described herein, including, for example, the user computing devices 103, 213, a web server (not shown), the financial services system 104, or components thereof. The architecture 700 comprises a processor unit 710. The processor unit 710 may include one or more processors. Any of a variety of different types of commercially available processors suitable for computing devices may be used (e.g., an XScale architecture microprocessor, a Microprocessor without Interlocked Pipeline Stages (MIPS) architecture processor, or another type of processor). A memory 720, such as a Random Access Memory (RAM), a flash memory, or another type of memory or data storage, is typically accessible to the processor unit 710. The memory 720 may be adapted to store an operating system (OS) 730, as well as application programs 740.

The processor unit 710 may be coupled, either directly or via appropriate intermediary hardware, to a display 750 and to one or more input/output (I/O) devices 760, such as a keypad, a touch panel sensor, a microphone, and the like. Such I/O devices 760 may include a touch sensor for capturing fingerprint data, a camera for capturing one or more images of the user, a retina scanner, or any other suitable devices. The I/O devices 760 may be used to implement I/O channels, as described herein. In some examples, the I/O devices 760 may also include sensors.

Similarly, in some examples, the processor unit 710 may be coupled to a transceiver 770 that interfaces with an antenna 790. The transceiver 770 may be configured to both transmit and receive cellular network signals, wireless data signals, or other types of signals via the antenna 790, depending on the nature of the computing device implemented by the architecture 700. Although one transceiver 770 is shown, in some examples, the architecture 700 includes additional transceivers. For example, a wireless transceiver may be utilized to communicate according to an IEEE 802.11 specification, such as Wi-Fi and/or a short-range communication medium. Some short-range communication mediums, such as NFC, may utilize a separate, dedicated transceiver. Further, in some configurations, a Global Positioning System (GPS) receiver 780 may also make use of the antenna 790 to receive GPS signals. In addition to or instead of the GPS receiver 780, any suitable location-determining sensor may be included and/or used, including, for example, a Wi-Fi positioning system. In some examples, the architecture 700 (e.g., the processor unit 710) may also support a hardware interrupt. In response to a hardware interrupt, the processor unit 710 may pause its processing and execute an interrupt service routine (ISR).

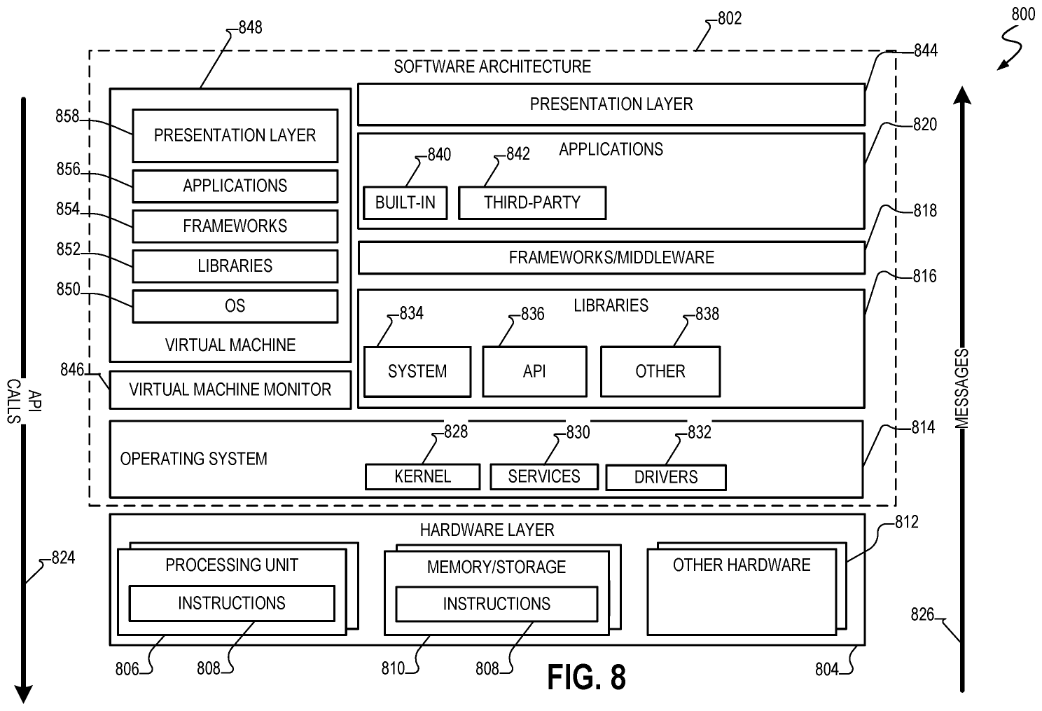

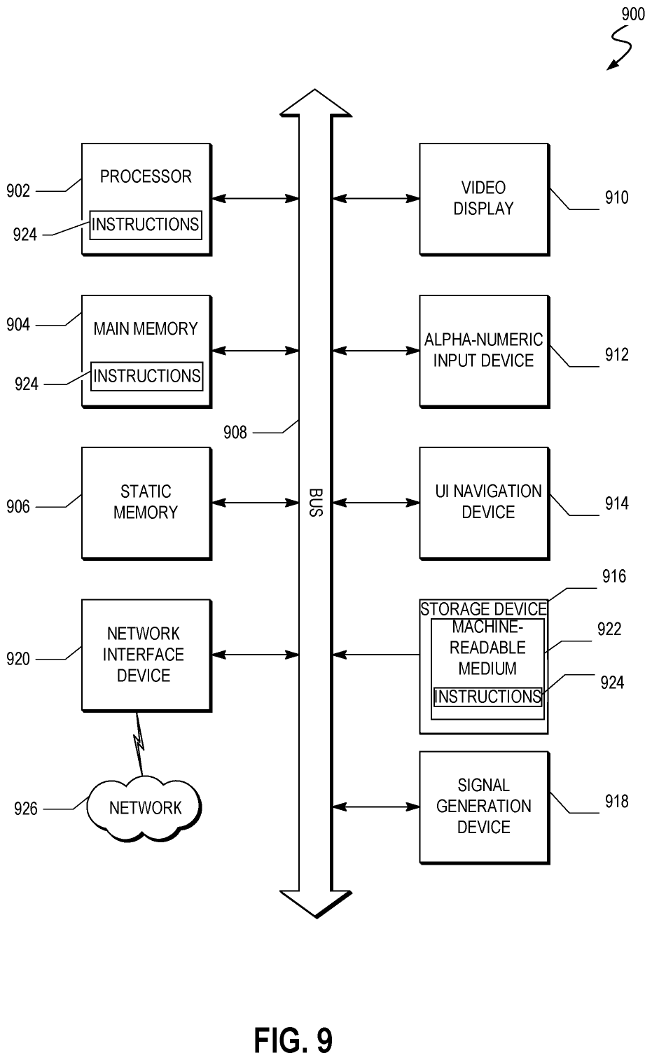

FIG. 8 is a block diagram 800 showing one example of a software architecture 802 for a computing device. The software architecture 802 may be used in conjunction with various hardware architectures, for example, as described herein. FIG. 8 is merely a non-limiting example of a software architecture 802, and many other architectures may be implemented to facilitate the functionality described herein. A representative hardware layer 804 is illustrated and can represent, for example, any of the above-referenced computing devices. In some examples, the hardware layer 804 may be implemented according to an architecture 900 of FIG. 9 and/or the architecture 700 of FIG. 7.

The representative hardware layer 804 comprises one or more processing units 806 having associated executable instructions 808. The executable instructions 808 represent the executable instructions of the software architecture 802, including implementation of the methods, modules, components, and so forth of FIGS. 1-7. The hardware layer 804 also includes memory and/or storage modules 810, which also have the executable instructions 808. The hardware layer 804 may also comprise other hardware 812, which represents any other hardware of the hardware layer 804, such as the other hardware illustrated as part of the architecture 900.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820, and a presentation layer 844. Operationally, the applications 820 and/or other components within the layers may invoke application programming interface (API) calls 824 through the software stack and receive a response, returned values, and so forth illustrated as messages 826 in response to the API calls 824. The layers illustrated are representative in nature and not all software architectures have all layers. For example, some mobile or special-purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of a hardware or software interrupt and, in response, cause the software architecture 802 to pause its current processing and execute an ISR when an interrupt is received. The ISR may generate an alert.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than by interfacing directly with the underlying operating system 814 functionality (e.g., kernel 828, services 830, and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 and/or other software components/modules. For example, the frameworks 818 may provide various graphical user interface (GUI) functions, high-level resource management, high-level location services, and so forth. The frameworks 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. The third-party applications 842 may include any of the built-in applications 840 as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 842 may invoke the API calls 824 provided by the mobile operating system such as the operating system 814 to facilitate functionality described herein.

The applications 820 may utilize built-in operating system functions (e.g., kernel 828, services 830, and/or drivers 832), libraries (e.g., system libraries 834, API libraries 836, and other libraries 838), or frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 8, this is illustrated by a virtual machine 848. A virtual machine creates a software environment where applications/modules can execute as if they were executing on a hardware computing device. The virtual machine 848 is hosted by a host operating system (e.g., the operating system 814) and typically, although not always, has a virtual machine monitor 846, which manages the operation of the virtual machine 848 as well as the interface with the host operating system (e.g., the operating system 814). A software architecture executes within the virtual machine 848, such as an operating system 850, libraries 852, frameworks/middleware 854, applications 856, and/or a presentation layer 858. These layers of software architecture executing within the virtual machine 848 can be the same as corresponding layers previously described or may be different.

Described implementations of the subject matter can include one or more features, alone or in combination as illustrated below by way of example. Each of these non-limiting examples can stand on its own or can be combined in various permutations or combinations with one or more of the other examples. The following examples detail certain aspects of the present subject matter to solve the challenges and provide the benefits discussed herein.

Example 1 is a system for detecting fraud in pay groups, the system comprising: at least one processor, and a machine-readable medium comprising instructions thereon that, when executed by the at least one processor, cause the at least one processor to perform operations comprising: receiving, at a server, a transaction authorization request related to a pay group on an account of a user; monitoring one or more events associated with at least one payee of the pay group; identifying a fraud indication among a first event of the one or more events associated with the at least one payee of the pay group; and triggering, by the fraud indication, stopping multiple payments to multiple payees of the pay group.

In Example 2, the subject matter of Example 1 optionally includes, wherein the machine-readable medium further includes the instructions thereon that, when executed by the at least one processor, cause the at least one processor to perform the operations comprising: analyzing one or more characteristics related to the one or more events associated with the at least one payee of the pay group, wherein the one or more characteristics can include one of enrollment attempts, login attempts, adding payee attempts, editing payee attempts, adding payment attempts, or editing payment attempts.

In Example 3, the subject matter of Example 2 optionally includes, wherein the machine-readable medium further includes the instructions thereon that, when executed by the at least one processor, cause the at least one processor to perform the operations comprising: identifying a fraud indication among a first event of the one or more events associated with the at least one payee of the pay group; and generating, in an automatic fashion, a fraud detection response based at least in part on the analysis of the one or more characteristics.

In Example 4, the subject matter of Example 3 optionally includes, wherein generating the fraud detection response causes the at least one processor to perform the operations comprising: causing the transaction authorization request related to the pay group to be declined for all payees in the pay group; and blocking the transaction authorization request related to the pay group, including stopping all payments to all payees of the pay group in response to the fraud indication associated with the at least one payee of the pay group.

In Example 5, the subject matter of Examples 1-4 optionally includes, wherein the fraud detection response includes one of blocking the transaction authorization request related to the pay group or allowing the transaction authorization request related to the pay group.

In Example 6, the subject matter of Examples 1-5 optionally includes, wherein the machine-readable medium further includes the instructions thereon that, when executed by the at least one processor, cause the at least one processor to perform the operations comprising: identifying fraudulent activity for a single payment in a group of payments associated with the pay group; and designating all payments associated with the pay group as fraudulent based at least in part on the identifying fraudulent activity for the single payment.

In Example 7, the subject matter of Examples 1-6 optionally includes, wherein the machine-readable medium further includes the instructions thereon that, when executed by the at least one processor, cause the at least one processor to perform the operations comprising: identifying fraudulent activity for a single payee associated with the pay group; and designating all payees associated with the pay group as fraudulent.

In Example 8, the subject matter of Examples 1-7 optionally includes, wherein the one or more events include at least one of enrollment, login, adding a payee to the pay group, editing the payee of the pay group, adding a payment to the pay group, or editing the payment of the pay group.

Example 9 is a method for detecting fraud in pay groups, the method comprising: receiving, at a server, a transaction authorization request related to a pay group on an account of a user; monitoring one or more events associated with at least one payee of the pay group; identifying a fraud indication among a first event of the one or more events associated with the at least one payee of the pay group; and triggering, by the fraud indication, stopping multiple payments to multiple payees of the pay group.

In Example 10, the subject matter of Example 9 optionally includes, analyzing one or more characteristics related to the one or more events associated with the at least one payee of the pay group, wherein the one or more characteristics can include one of enrollment attempts, login attempts, adding payee attempts, editing payee attempts, adding payment attempts, or editing payment attempts.

In Example 11, the subject matter of Example 10 optionally includes, identifying a fraud indication among a first event of the one or more events associated with the at least one payee of the pay group; and generating, in an automatic fashion, a fraud detection response based at least in part on the analysis of the one or more characteristics.

In Example 12, the subject matter of Example 11 optionally includes, wherein generating the fraud detection response causes the at least one processor to perform the operations comprising: causing the transaction authorization request related to the pay group to be declined for all payees in the pay group; and blocking the transaction authorization request related to the pay group, including stopping all payments to all payees of the pay group in response to the fraud indication associated with the at least one payee of the pay group.

In Example 13, the subject matter of Examples 9-12 optionally includes, wherein the fraud detection response includes one of blocking the transaction authorization request related to the pay group or allowing the transaction authorization request related to the pay group.

In Example 14, the subject matter of Examples 9-13 optionally includes, identifying fraudulent activity for a single payment in a group of payments associated with the pay group, and designating all payments associated with the pay group as fraudulent based at least in part on the identifying fraudulent activity for the single payment.

In Example 15, the subject matter of Examples 9-14 optionally includes, identifying fraudulent activity for a single payment in a group of payments associated with the pay group, and designating all payments associated with the pay group as fraudulent.

In Example 16, the subject matter of Examples 9-15 optionally includes, wherein the one or more events include at least one of enrollment, login, adding a payee to the pay group, editing the payee of the pay group, adding a payment to the pay group, or editing the payment of the pay group.

Example 17 is a non-transitory machine-readable storage medium having instructions thereon that, when executed by at least one processor, cause the at least one processor to perform operations comprising: receiving, at a server, a transaction authorization request related to a pay group on an account of a user; monitoring one or more events associated with at least one payee of the pay group; identifying a fraud indication among a first event of the one or more events associated with the at least one payee of the pay group; and triggering, by the fraud indication, stopping multiple payments to multiple payees of the pay group.

In Example 18, the subject matter of Example 17 optionally includes, wherein the machine-readable storage device further includes the instructions that, when executed by the at least one processor, cause the at least one processor to perform the operations comprising: analyzing one or more characteristics related to the one or more events associated with the at least one payee of the pay group, wherein the one or more characteristics can include one of enrollment attempts, login attempts, adding payee attempts, editing payee attempts, adding payment attempts, or editing payment attempts.

In Example 19, the subject matter of Example 18 optionally includes, wherein the machine-readable storage device further includes the instructions that, when executed by the at least one processor, cause the at least one processor to perform the operations comprising: identifying a fraud indication among a first event of the one or more events associated with the at least one payee of the pay group; and generating, in an automatic fashion, a fraud detection response based at least in part on the analysis of the one or more characteristics.

In Example 20, the subject matter of Example 19 optionally includes, wherein the machine-readable storage device further includes the instructions that, when executed by the at least one processor, cause the at least one processor to perform the operations comprising: causing the transaction authorization request related to the pay group to be declined for all payees in the pay group; and blocking the transaction authorization request related to the pay group, including stopping all payments to all payees of the pay group in response to the fraud indication associated with the at least one payee of the pay group.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

FIG. 9 is a block diagram illustrating a computing device hardware architecture 900, within which a set or sequence of instructions can be executed to cause a machine to perform examples of any one of the methodologies discussed herein. The architecture 900 may describe, for example, any of the computing devices and/or control circuits described herein. The architecture 900 may execute the software architecture 802 described with respect to FIG. 8. The architecture 900 may operate as a standalone device or may be connected (e.g., networked) to other machines. In a networked deployment, the architecture 900 may operate in the capacity of either a server or a client machine in server-client network environments, or it may act as a peer machine in peer-to-peer (or distributed) network environments. The architecture 900 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 900 includes a processor unit 902 comprising at least one processor (e.g., a central processing unit (CPU), a graphics processing unit (GPU), or both, processor cores, compute nodes, etc.). The architecture 900 may further comprise a main memory 904 and a static memory 906, which communicate with each other via a link 908 (e.g., a bus). The architecture 900 can further include a video display unit 910, an alphanumeric input device 912 (e.g., a keyboard), and a UI navigation device 914 (e.g., a mouse). In some examples, the video display unit 910, alphanumeric input device 912, and UI navigation device 914 are incorporated into a touchscreen display. The architecture 900 may additionally include a storage device 916 (e.g., a drive unit), a signal generation device 918 (e.g., a speaker), a network interface device 920, and one or more sensors (not shown), such as a GPS sensor, compass, accelerometer, or other sensor.

In some examples, the processor unit 902 or another suitable hardware component may support a hardware interrupt. In response to a hardware interrupt, the processor unit 902 may pause its processing and execute an ISR, for example, as described herein.

The storage device 916 includes a machine-readable medium 922 on which is stored one or more sets of data structures and instructions 924 (e.g., software) embodying or utilized by any one or more of the methodologies or functions described herein. The instructions 924 can also reside, completely or at least partially, within the main memory 904, within the static memory 906, and/or within the processor unit 902 during execution thereof by the architecture 900, with the main memory 904, the static memory 906, and the processor unit 902 also constituting machine-readable media. The instructions 924 stored at the machine-readable medium 922 may include, for example, instructions for implementing the software architecture 802, instructions for executing any of the features described herein, etc.

While the machine-readable medium 922 is illustrated in an example to be a single medium, the term “machine-readable medium” can include a single medium or multiple media (e.g., a centralized or distributed database, and/or associated caches and servers) that store the one or more instructions 924. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM) and electrically erasable programmable read-only memory (EEPROM)) and flash memory devices; magnetic disks such as internal hard disks and removable disks; magneto-optical disks; and CD-ROM and DVD-ROM disks.

The instructions 924 can further be transmitted or received over a communications network 926 using a transmission medium via the network interface device 920 utilizing any one of a number of well-known transfer protocols (e.g., hypertext transfer protocol (HTTP)). Examples of communication networks include a LAN, a WAN, the Internet, mobile telephone networks, plain old telephone service (POTS) networks, and wireless data networks (e.g., Wi-Fi, 3G, and 5G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Examples, as described herein, may include, or may operate by, logic, a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

As used herein, the terms “machine-storage medium,” “device-storage medium,” and “computer-storage medium” mean the same thing and can be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices, magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

The terms “machine-readable medium,” “computer-readable medium,” and “device-readable medium” mean the same thing and can be used interchangeably in this disclosure. The terms are defined to include both machine-storage media and transmission media. Thus, the terms include both storage devices/media and carrier waves/modulated data signals.

The various operations of example methods described herein can be performed, at least partially, by one or more processors that are temporarily configured (e.g., by software) or permanently configured to perform the relevant operations. Similarly, the methods described herein can be at least partially processor implemented. For example, at least some of the operations of the methods described herein can be performed by one or more processors. The performance of certain of the operations can be distributed among the one or more processors, not only residing within a single machine, but also deployed across a number of machines. In some example embodiments, the processor or processors can be located in a single location (e.g., within a home environment, an office environment, or a server farm), while in other embodiments the processors can be distributed across a number of locations.

Although the embodiments of the present disclosure have been described with reference to specific example embodiments, it will be evident that various modifications and changes can be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter can be practiced. The embodiments illustrated are described in sufficient detail to enable those skilled in the art to practice the teachings disclosed herein. Other embodiments can be used and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B.” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in an aspect are still deemed to fall within the scope of that aspect. Moreover, in the following aspects, the terms “first,” “second,” and “third,” etc. are used merely as labels, and are not intended to impose numerical requirements on their objects

Method examples described herein may be machine or computer-implemented at least in part. Some examples may include a computer-readable medium, non-transitory computer-readable medium, or machine-readable medium encoded with instructions operable to configure an electronic device to perform methods as described in the above examples. An implementation of such methods may include code, such as microcode, assembly language code, a higher-level language code, or the like Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A system for detecting fraud in pay groups, the system comprising:
at least one processor; and
a machine-readable medium comprising instructions thereon that, when executed by the at least one processor, cause the at least one processor to perform operations comprising:
receiving, at a server, a transaction authorization request related to a pay group on an account of a user;
monitoring one or more events associated with at least one payee of the pay group;
identifying a fraud indication among a first event of the one or more events associated with the at least one payee of the pay group; and
triggering, in response to the fraud indication, stopping multiple payments to multiple payees of the pay group.

2. The system of claim 1, wherein the machine-readable medium further includes the instructions thereon that, when executed by the at least one processor, cause the at least one processor to perform the operations comprising:
analyzing one or more characteristics related to the one or more events associated with the at least one payee of the pay group, wherein the one or more characteristics can include one of enrollment attempts, login attempts, adding payee attempts, editing the payee attempts, adding payment attempts, or editing the payment attempts.

3. The system of claim 2, wherein the machine-readable medium further includes the instructions thereon that, when executed by the at least one processor, cause the at least one processor to perform the operations comprising:
generating, in an automatic fashion, a fraud detection response based at least in part on the analyzing the one or more characteristics.

4. The system of claim 3, wherein generating the fraud detection response causes the at least one processor to perform the operations comprising:
causing the transaction authorization request related to the pay group to be declined for all payees in the pay group; and
blocking the transaction authorization request related to the pay group, including stopping all payments to all payees of the pay group in response to the fraud indication associated with the at least one payee of the pay group.

5. The system of claim 4, wherein the fraud detection response includes one of blocking the transaction authorization request related to the pay group or allowing the transaction authorization request related to the pay group.

6. The system of claim 1, wherein the machine-readable medium further includes the instructions thereon that, when executed by the at least one processor, cause the at least one processor to perform the operations comprising:
identifying fraudulent activity for a single payment in a group of payments associated with the pay group; and
designating all payments associated with the pay group as fraudulent based at least in part on the identifying the fraudulent activity for the single payment.

7. The system of claim 1, wherein the machine-readable medium further includes the instructions thereon that, when executed by the at least one processor, cause the at least one processor to perform the operations comprising:
identifying fraudulent activity for a single payee associated with the pay group; and
designating all payees associated with the pay group as fraudulent.

8. The system of claim 1, wherein the one or more events include at least one of enrollment, login, adding a payee to the pay group, editing the payee of the pay group, adding a payment to the pay group, or editing the payment of the pay group.

9. A method for detecting fraud in pay groups, the method comprising:
receiving, at a server, a transaction authorization request related to a pay group on an account of a user;
monitoring one or more events associated with at least one payee of the pay group;
identifying a fraud indication among a first event of the one or more events associated with the at least one payee of the pay group; and
triggering, by the fraud indication, stopping multiple payments to multiple payees of the pay group.

10. The method of claim 9, further comprising:
analyzing one or more characteristics related to the one or more events associated with the at least one payee of the pay group, wherein the one or more characteristics can include one of enrollment attempts, login attempts, adding payee attempts, editing the payee attempts, adding payment attempts, or editing the payment attempts.

11. The method of claim 10, further comprising:
identifying a fraud indication among a first event of the one or more events associated with the at least one payee of the pay group; and
generating, in an automatic fashion, a fraud detection response based at least in part on the analyzing the one or more characteristics.

12. The method of claim 11, wherein generating the fraud detection response causes at least one hardware processor to perform operations comprising:
causing the transaction authorization request related to the pay group to be declined for all payees in the pay group; and
blocking the transaction authorization request related to the pay group, including stopping all payments to all payees of the pay group in response to the fraud indication associated with the at least one payee of the pay group.

13. The method of claim 12, wherein the fraud detection response includes one of blocking the transaction authorization request related to the pay group or allowing the transaction authorization request related to the pay group.

14. The method of claim 9, further comprising:
identifying fraudulent activity for a single payment in a group of payments associated with the pay group; and
designating all payments associated with the pay group as fraudulent based at least in part on the identifying fraudulent activity for the single payment.

15. The method of claim 9, further comprising:
identifying fraudulent activity for a single payment in a group of payments associated with the pay group; and
designating all payments associated with the pay group as fraudulent.

16. The method of claim 9, wherein the one or more events include at least one of enrollment, login, adding a payee to the pay group, editing the payee of the pay group, adding a payment to the pay group, or editing the payment of the pay group.

17. A non-transitory machine-readable storage medium having instructions thereon that, when executed by at least one processor, cause the at least one processor to perform operations comprising:
receiving, at a server, a transaction authorization request related to a pay group on an account of a user;
monitoring one or more events associated with at least one payee of the pay group;
identifying a fraud indication among a first event of the one or more events associated with the at least one payee of the pay group; and
triggering, by the fraud indication, stopping multiple payments to multiple payees of the pay group.

18. The non-transitory machine-readable storage medium of claim 17,
wherein the machine-readable storage medium further includes the instructions that, when executed by the at least one processor, cause the at least one processor to perform the operations comprising:
analyzing one or more characteristics related to the one or more events associated with the at least one payee of the pay group, wherein the one or more characteristics can include one of enrollment attempts, login attempts, adding payee attempts, editing the payee attempts, adding payment attempts, or editing the payment attempts.

19. The non-transitory machine-readable storage medium of claim 18, wherein the machine-readable storage medium further includes the instructions that, when executed by the at least one processor, cause the at least one processor to perform the operations comprising:
identifying the fraud indication among the first event of the one or more events associated with the at least one payee of the pay group; and
generating, in an automatic fashion, a fraud detection response based at least in part on the analyzing the one or more characteristics.

20. The non-transitory machine-readable storage medium of claim 19, wherein the machine-readable storage medium further includes the instructions that, when executed by the at least one processor, cause the at least one processor to perform the operations comprising:
causing the transaction authorization request related to the pay group to be declined for all payees in the pay group; and
blocking the transaction authorization request related to the pay group, including stopping all payments to all payees of the pay group in response to the fraud indication associated with the at least one payee of the pay group.
